(19) United States
(12) Patent Application Publication
(10) Pub. No.: US 2016/0165684 A1
(43) Pub. Date: Jun. 9, 2016

(54) POWER CONVERSION SYSTEM

(71) Applicant: General Electric Company, Schenectady, NY (US)

(72) Inventors: Ramanujam Ramabhadran, Niskayuna, NY (US); John Stanley Glaser, Niskayuna, NY (US)

(21) Appl. No.: 14/561,942

(22) Filed: Dec. 5, 2014

(51) Int. Cl. H05B 33/08

(52) U.S. Cl. CPC H05B 33/0815

(57) ABSTRACT

An illumination device is provided. The illumination device includes a light emitting source, and a clamped series resonant converter operatively coupled to the light emitting source, where the clamped series resonant converter is configured to automatically regulate a load current generated by the clamped series resonant converter in response to a load voltage applied by the light emitting source.

### BACKGROUND

The invention generally relates to power converter system and, more particularly, to a power converter system applicable in an illumination device.

Conventional LED devices include a light emitting source coupled to the power converter assembly. The power converter assembly includes different configurations which may be used to supply power to the LED device. One such configuration includes a rectifier operatively coupled to a flyback converter. The rectifier receives alternating current (AC) power from a power source and converts the AC power to direct current (DC) power. The AC power is sinusoidal and varies with time which leads to ripples/variations in the DC power. Therefore, the flyback converter is coupled to the rectifier to convert the DC power generated by the rectifier to generate a constant DC power, which is supplied to the light emitting source.

However, using such a configuration results in a large size and increased cost of the LED device. Due to the size is the power converter configuration, an LED shell of corresponding size of the power converter is required which increases costs of the LED device. Moreover, the large size of the LED device increases weight of the LED device.

Hence, there is a need for an improved power conversion system.

### BRIEF DESCRIPTION

Briefly, in accordance with one embodiment, an illumination device is provided. The illumination device includes a light emitting source, and a clamped series resonant converter operatively coupled to the light emitting source, where the clamped series resonant converter is configured to automatically regulate a load current generated by the clamped series resonant converter in response to a load voltage applied by the light emitting source.

In another embodiment, a method for regulating current in an illumination device is provided. The method includes converting alternating current (AC) power to direct current (DC) power using an AC-DC power converter. The method also includes generating a load current in response to a load voltage applied by a light emitting source using a DC-DC converter. The method further includes automatically regulating the load current flowing through the light emitting source based solely on a switching frequency of the DC-DC power converter for providing a fixed DC power to the light emitting source.

In yet another embodiment, a method for illuminating an illumination device is provided. The method includes operatively coupling an alternating current (AC) to direct current (DC) power converter to a power source, converting AC power received from the power source to DC power using the AC-DC power converter, operatively coupling the AC-DC power converter to a clamped series resonant converter, operatively coupling the clamped series resonant converter to a string of one or more light emitting diodes (LED), and generating a load current in response to a load voltage applied by the string of one or more light emitting diodes, where the load current is automatically regulated by the clamped series resonant converter upon operating the clamped series resonant converter as an automatic power factor corrector for providing fixed power to the string of one or more light emitting diodes.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of an illumination device including a clamped series resonator converter in accordance with an embodiment of the invention.

FIG. 2 is a flow chart representing steps involved in a method for regulating current in an illumination device in accordance with an embodiment of the invention.

FIG. 3 is a flow chart representing steps involved in a method for illuminating an illumination device in accordance with an embodiment of the invention.

### DETAILED DESCRIPTION

Embodiments of the present invention include an illumination device and a method for illuminating the illumination device without using a feedback loop for regulating a current in the illumination device is provided. The inventive illumination device and method for illuminating the illumination device advantageously provide a smaller gate driver circuit when compared to gate driver circuits in conventional illumination devices. Such smaller gate driver circuit is enabled by the use of a clamped series resonator converter which uses a smaller transformer, when compared to the conventional gate driver circuits. Therefore, use of smaller gate driver circuits reduces size of the illumination device. Furthermore, the clamped series resonator converter provides automatic regulation of the load current that flows within the light emitting source without the need for regulation of the load current using the feedback loop. Such automatic regulation of the load current increases efficiency of the illumination device. Also due to the omission of the feedback loop to regulate the load current, the clamped series resonator converter uses lesser components, which further reduces cost of the illumination device.

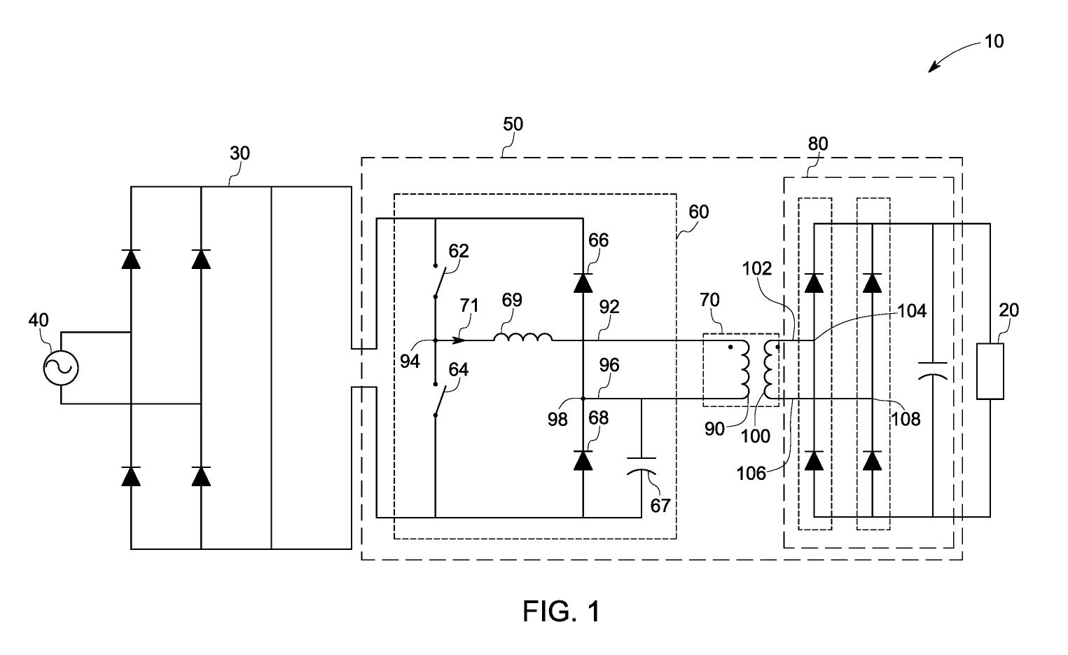

FIG. 1 is a schematic representation of an illumination device 10 in accordance with an embodiment of the invention. The illumination device 10 includes a light emitting source 20. As described herein, the light emitting source 20 may also be referred as a load 20. In one embodiment, the light emitting source 20 may include a string of one or more light emitting diodes (LEDs). The illumination device 10 also includes an alternating current (AC) to direct current (DC) power converter 30 which is configured to convert an AC power received from a power source 40. In one embodiment, the AC-DC power converter 30 may include a high frequency filter coupled in parallel to a diode bridge in the AC-DC power converter 30. The power source 40 provides the AC power to the AC-DC power converter 30 in the illumination device 10 which converts the AC power to DC power.

The illumination device 10 further includes a clamped series resonant converter (CSRC) 50 which operates as a DC-DC converter and generates a load current in response to a load voltage applied by the light emitting source 20. To this end, the CSRC 50 includes an inverter 60 that converts the DC power to an intermediate AC power. The inverter 60 includes two switches 62, 64 operatively coupled in series to each other and two diodes 66, 68 operatively coupled to each other in series. Furthermore, the two switches 62, 64 and the two diodes 66, 68 are operatively coupled in parallel to each other. In one embodiment, the inverter 60 may include more than two switches operatively coupled in series to each other. In another embodiment, the inverter 60 may include more than two diodes operatively coupled in series to each other. In one embodiment, each of the two switches 62, 64 may include an insulated gate bipolar transistor. The inverter 60 also includes a resonator capacitor 67 and a resonator inductor 69 configured to form a tank circuit (not shown) in the inverter 60.

In operation, the DC power having a DC voltage is fed to the inverter 60 which generates the intermediate AC power with an AC voltage, where a root mean square voltage of the AC voltage is equivalent to the load voltage. The two switches 62, 64 are switched based on a predetermined modulation technique in combination with the resonator capacitor 67 and the resonator inductor 69 to generate the intermediate AC power from the DC power. In one embodiment, the inverter 60 operates in a discontinuous mode of operation. In such an embodiment, voltage and the current pulses generated during the operation of the inverter 60 are determined by the resonator inductor 69, the resonator capacitor 67, the DC voltage and a duty cycle of the predetermined modulation technique. Therefore, an AC current component in the intermediate AC power generated by the inverter 60 at its output is controlled using a pulse rate determined by the predetermined modulation technique. Such control of the AC current component using the pulse rate enables controlling the inverter 60 based on a predetermined fixed switching frequency of the CSRC 50. Consequently, the CSRC 50 may be operated as a constant power source by only controlling the switching frequency of the CSRC 50 irrespective of the voltage and current component of the intermediate AC power. Such operation of the CSRC at the predetermined fixed frequency enables the CSRC to emulate as a resistor, which further enables the CSRC to operate as an automatic power factor corrector. The characteristic of the CSRC to operate as the automatic power factor corrector allows the CSRC to provide a fixed power at its output. Since the output power of the CSRC is fixed and the load voltage is fixed, the load current flowing through the load also becomes constant. In one embodiment, the predetermined modulation technique may be chosen based on one or more criteria, where the one or more criteria may include a value representative of the AC power, a value representative of a power rating of the light emitting source, and a turn ratio of a transformer in the CSRC. In one embodiment, the inverter 60 in the CSRC 50 operates in a zero voltage switching (ZVS) mode or a Zero Current Switching (ZCS) mode.

The CSRC 50 also includes a transformer 70 that is used to transmit the intermediate AC power generated by the inverter 60 to a rectifier 80 operatively coupled to the transformer 70. The transformer 70 includes a primary winding 90 and a secondary winding 100. A first primary leg 92 of the primary winding 90 is operatively coupled to the two switches 62, 64 at a first primary node 94 and a second primary leg 96 is operatively coupled to the two diodes 66, 68 at a second primary node 98. The resonator inductor 69 is operatively coupled to the first primary leg 92 and the resonator capacitor 67 is operatively coupled to the second primary leg 96. Furthermore, the secondary winding 100 is operatively coupled the rectifier 80 in the CSRC 50, where a first secondary leg 102 is operatively coupled to a first set 104 of diodes in the rectifier 80 and a second secondary leg 106 is operatively coupled to a second set 108 of diodes in the rectifier 80. The diodes in the first set 104 and the second set 108 are operatively coupled in series to each other.

During normal operation, the CSRC 50 operates in a zero current switching (ZCS) mode. The resonant inductor 69 in the inverter enables the CSRC 50 to operate in the ZCS mode. The ZCS mode is achieved based on a value of the resonator inductor 69. A small value of the resonator inductor 69 may lead to faster deterioration of current in the resonator inductor during a switching cycle when compared to a higher value of the resonator inductor 69. However, the smaller value of the resonator inductor 69 may lead to a decrease in a conduction time, and may subsequently result in a decrease in efficiency. Therefore, in order to achieve faster deterioration of current in the resonator inductor 69 without reducing the efficiency, a turn ratio of the transformer 70 is maintained such that for the same resonator inductor 69, a voltage at the resonator inductor 69 may increase with respect to the transformer, which forces the current to deteriorate faster in the resonator inductor 69. Such a configuration of the transformer 70 including the turn ratio corresponding to the resonator inductor 69 reduces root mean square losses on the switches and increases efficiency of the CSRC 50.

The transformer 70 may further include a leakage inductance and a magnetizing inductance. The leakage inductance is induced in the CSRC due to the parasitic behavior of the transformer. In embodiments, where a value of the leakage inductance of the transformer 70 is equivalent to the resonator inductor 69, the resonator inductor 69 may be replaced by the leakage inductance. Furthermore, the magnetizing inductance in the transformer 70 induces a magnetizing current 71 in the CSRC. Such magnetizing current 71 enables the CSRC to operate in a Zero Voltage Switching (ZVS) mode and also helps in recovering additional power. In some embodiment, the gate pulses for switching the two switches 62, 64 may be such that the switches switch from a conducting state to non-conducting state or vice versa, before the current in the resonator inductor 69 reaches zero. In such conditions, switches 62, 64 achieve their ZCS boundary conditions and when the switches are in a non-conducting state, a voltage develops in the switches 62, 64 due to an inherent switch capacitance in the switches 62, 64. Subsequently, upon switching the switches to a conducting state, the CSRC 50 is unable to use such voltages to recover additional power resulting in losses, however, the magnetizing current 71 helps in recovering such lost power by using such voltages to deliver additional power to the light emitting source 20. Such recovery of the additional power further increases efficiency of the illumination device 10. In one embodiment, the CSRC may operate in a partial ZVS mode or a full ZVS mode. The full ZVS mode may represent a condition where, the voltage at the switches 62, 64 during the switching of the switches 63, 64 is zero. However, the partial ZVS mode may represent a condition where, the magnetizing current is able to recover a portion of the lost power by reducing the voltage at the switches 62, 64 up to a certain limit which may correspond to the gate pulses.

In continuation to the operation of the transformer 70, as the first primary leg 102 and the second primary leg 106 of the transformer 70 are operatively coupled to the two switches 62, 64 and the two diodes 66, 68 of the inverter 60 respectively, the current pulses of the AC current component generated by the inverter 60 during its operation, flow within the primary winding 90. Such flow of current in the primary winding 90 induces a corresponding AC current pulse in the secondary winding 100 due to the magnetic coupling between the primary winding 90 and the secondary winding 100. In one embodiment, the corresponding AC current generated in the secondary winding 100 is based on a turn ratio of the transformer.

Such corresponding AC current pulses are used by the rectifier 80 to convert the intermediate AC power to an output DC power. In such a scenario, since the load voltage is fixed and the CSRC provides fixed power at a fixed predetermined frequency, the load current automatically remains constant which is further applied to the light emitting source for illumination. Therefore, as described herein, the AC-DC power converter receives the AC power from the power source 40 and converts the AC power to DC power. The CSRC 50 receives the DC power and converts the DC power to output DC power. The CSRC 50 emulates as a resistor upon operating at a fixed predetermined frequency and provides automatic power factor correction to the DC power. This enables the CSRC 50 to provide a fixed output DC power. Therefore, upon operatively coupling the CSRC 50 to the light emitting source 20, the load current in the illumination device 10 is regulated automatically without using a closed loop control for sensing and rectifying an error determined by a feedback loop. As discussed above, since the load voltage is fixed and the CSRC 50 provides a constant output DC power at a fixed predetermined switching frequency, the load current automatically becomes constant without the need for regulation.

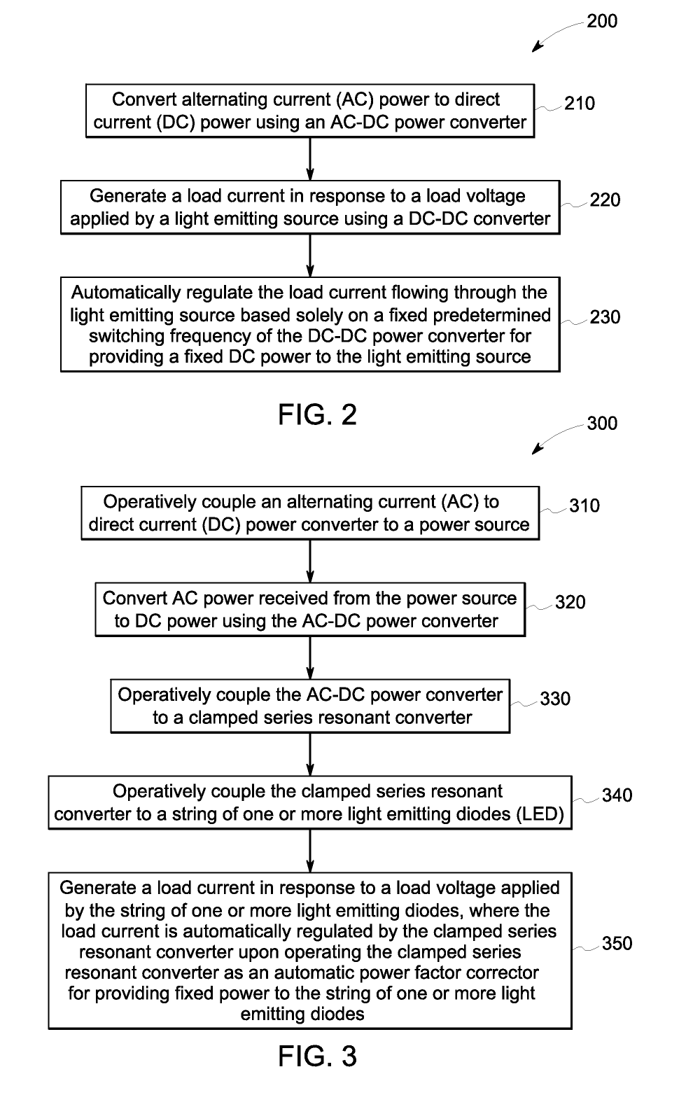

FIG. 2 is a flow chart representing steps involved in a method 200 for regulating current in an illumination device in accordance with an embodiment of the invention. The method 200 includes converting alternating current (AC) power to direct current (DC) power using an AC-DC power converter in step 210. In one embodiment, a power factor corrector AC-DC power converter is used to convert the alternating current (AC) power to the direct current (DC) power. The method 200 also includes generating a load current in response to a load voltage applied by a light emitting source using a DC-DC converter in step 220. In one embodiment, a clamped series resonator converter is used to generate the load current in response to the load voltage applied by the light emitting source. In a specific embodiment, the clamped series resonant converter is operated at the fixed predetermined switching frequency to provide an automatic power factor correction to DC power received from the AC-DC power converter for providing the fixed power to the light emitting source. In another embodiment, a magnetizing inductance is induced in the clamped series resonant converter for operating the clamped series resonant converter in a zero voltage switching (ZVS) mode. In another embodiment, the clamped series resonant converter is operated in a zero voltage switching mode (ZVS) upon achieving a zero current switching (ZCS) boundary condition. In a specific embodiment, the clamped series resonant converter operates in a partial zero voltage switching mode. The method 200 further includes automatically regulating the load current flowing through the light emitting source based solely on a fixed predetermined switching frequency of the DC-DC power converter for providing a fixed DC power to the light emitting source in step 230.

FIG. 3 is a flow chart representing steps involved in a method 300 for illuminating an illumination device in accordance with an embodiment of the invention. The method 300 includes operatively coupling an alternating current (AC) to direct current (DC) power converter to a power source in step 310. The method 300 also includes converting AC power received from the power source to DC power using the AC-DC power converter in step 320. The method 300 further includes operatively coupling the AC-DC power converter to a clamped series resonant converter in step 330. The method 300 also includes operatively coupling the clamped series resonant converter to a string of one or more light emitting diodes (LED) in step 340. The method 300 further includes generating a load current in response to a load voltage applied by the string of one or more light emitting diodes, where the load current is automatically regulated by the clamped series resonant converter upon operating the clamped series resonant converter as an automatic power factor corrector for providing fixed power to the string of one or more light emitting diodes. In one embodiment, the load current is automatically regulated based on a predetermined fixed switching frequency of the clamped series resonant converter.

It is to be understood that a skilled artisan will recognize the interchangeability of various features from different embodiments and that the various features described, as well as other known equivalents for each feature, may be mixed and matched by one of ordinary skill in this art to construct additional systems and techniques in accordance with principles of this disclosure. It is, therefore, to be understood that the appended claims are intended to cover all such modifications and changes as fall within the true spirit of the invention.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An illumination device comprising:
a light emitting source; and
a clamped series resonant converter electrically coupled to the light emitting source, wherein the clamped series resonant converter comprises an input and an output, and wherein the clamped series resonant converter is configured to receive a direct current (DC) power at the input and supply a fixed output DC power to the light emitting source via the output to automatically regulate a load current generated by the clamped series resonant converter in response to a load voltage applied by the light emitting source.

2. The illumination device of claim 1, wherein the light emitting source comprises a string of one or more light emitting diodes.

3. The illumination device of claim 1, further comprising an alternating current (AC) to DC power converter for converting AC power received from a power source to the DC power.

4. (canceled)

5. The illumination device of claim 1, wherein the load voltage applied by the light emitting source is fixed and the clamped series resonant converter automatically regulates the load current to provide the fixed output DC power to the light emitting source.

6. The illumination device of claim 5, wherein the clamped series resonant converter automatically regulates the load current based on a switching frequency of the clamped series resonant converter, wherein the switching frequency comprises a predetermined fixed frequency.

7. The illumination device of claim 1, wherein the clamped series resonant converter comprises a magnetizing inductance induced by a transformer in the clamped series resonant converter when operatively coupled to the light emitting source.

8. The illumination device of claim 7, wherein the magnetizing inductance enables a zero voltage switching (ZVS) in the clamped series resonant converter.

9. The illumination device of claim 1, wherein the clamped series resonant converter operates in a zero voltage switching mode (ZVS) upon achieving a zero current switching (ZCS) boundary condition.

10. The illumination device of claim 7, wherein the clamped series resonant converter operates in a partial zero voltage switching mode or a full zero voltage switching mode.

11. A method for regulating current in an illumination device comprising:
converting an alternating current (AC) power to a direct current (DC) power using an AC-DC power converter;
receiving the DC power at an input of a clamped series resonant converter from the AC-DC power converter; and
supplying a fixed output DC power to the light emitting source via an output of the clamped series resonant converter such that a load current flowing through the light emitting source is automatically regulated based solely on a fixed predetermined switching frequency of the clamped series resonant converter.

12. (canceled)

13. The method of claim 11, further comprising operating the clamped series resonant converter at the fixed predetermined switching frequency for providing an automatic power factor correction to the DC power received from the AC-DC power converter for providing the fixed output DC power to the light emitting source.

14. The method of claim 12, wherein using the clamped series resonant converter for generating the load current in response to the load voltage comprises inducing a magnetizing inductance in the clamped series resonant converter for operating the clamped series resonant converter in a zero voltage switching (ZVS) mode.

15. The method of claim 12, wherein using the clamped series resonant converter for generating the load current in response to the load voltage comprises operating the clamped series resonant converter in a zero voltage switching mode (ZVS) upon achieving a zero current switching (ZCS) boundary condition.

16. The method of claim 15, further comprising operating the clamped series resonant converter in a partial zero voltage switching mode.

17. (canceled)

18. (canceled)

19. The illumination device of claim 1, wherein the clamped series resonant converter further comprises an inverter configured to generate an intermediate AC power, wherein the clamped series resonant converter comprises:
a plurality of switches coupled in series with each other; and
a plurality of diodes coupled in series with each other, wherein the plurality of switches is coupled in parallel with the plurality of diodes.

20. The illumination device of claim 19, wherein the clamped series resonant converter further comprises a transformer comprising a primary winding and a secondary winding, wherein the primary winding is electrically coupled to the inverter to receive the intermediate AC power.

21. The illumination device of claim 20, wherein the clamped series resonant converter further comprises a rectifier coupled to the secondary winding of the transformer to convert the intermediate AC power to the fixed output DC power.

22. The illumination device of claim 20, wherein the inverter further comprises:
a resonator inductor coupled to the plurality of the switches; and
a resonator capacitor coupled to the plurality of diodes to facilitate generation of the intermediate AC power, wherein the resonator inductor and the resonator capacitor are coupled to the primary winding of the transformer.
